(19) United States
(12) Patent Application Publication
(10) Pub. No.: US 2002/0104392 A1
(43) Pub. Date: Aug. 8, 2002

(54) Centripetal linear and rotary propulsion device

(76) Inventor: Lawrence D. Murray, Kingsland, GA (US)

Correspondence Address: HINKLE & O'BRADOVICH, LLC, 395 SCENIC HIGHWAY, LAWERENCEVILLE, GA, 30045, US

(21) Appl. No.: 10/071,055

(22) Filed: Feb. 7, 2002

Related U.S. Application Data
(60) Provisional application No. 60/267,340, filed on Feb. 8, 2001.

(51) Int. Cl. F16H 33/20

(52) U.S. Cl. 74/84 S

(57) ABSTRACT

A mechanical force generator for producing an unidirectional force by converting rotational force energy to a directional force by rotating a cage assembly about its longitudinal axis, which then turns a sun gear and planet gears to move opposing eccentrics to vary the radii of the center of mass of the eccentrics to produce a directional force. A timing mechanism is connected to the cage to change the phase relationship between the cage and axis to vary the resultant force output.

This application is a utility application which claims the benefit of priority of U.S. Provisional Patent Application No. 60/267,340, filed on Feb. 8, 2001, entitled “Centripetal Linear And Rotary Propulsion Device”.

### BACKGROUND OF THE INVENTION

I. Field of the Invention.

The present invention relates generally to a force generator apparatus for producing a directional force, and more particularly to an apparatus for converting rotational energy to a directional force by rotating an assembly about its longitudinal axis which then turn crank throws, upon which eccentrics are mounted, to revolve around the longitudinal axis to produce a net unidirectional force in a desired direction.

II. Description of the Related Art.

Various devices are well known in the prior art which transmit energy and converts that energy from linear to rotational and vice versa. Many such devices use eccentrics to modify the resultant force output.

For instance, the patent to Mount (U.S. Pat. No. 4,072,066) discloses a transmission which uses eccentrics to control power output by having the eccentrics mounted transversely to the drive axis to modify the drive ratio of a planetary gear transmission by centrifugal force associated with a rotor assembly having an imbalance that varies as a function of the speed of oppositely rotating eccentric rotor elements relative to a carrier frame mounting planetary gears drivingly connected to a spider on which the rotor assembly is mounted.

In the Peterson Patent (U.S. Pat. No. 4,744,259) there is disclosed a device for generating a unidirectional force comprising a rotary body carrying around its periphery a plurality of pivotal pendulum masses mounted on shafts parallel to the axis of rotation of the rotary body so that the pendulum masses swing transversely to the main access of rotation. As the device rotates, each pendulum mass flings outwardly to produce a unidirectional force symmetrical about a central axis.

The Moller Patent (U.S. Pat. No. 4,307,629) discloses a torque converter having an input shaft, an output shaft and preferably three or more torque generating trains each having a rotatable shaft whose axes are fixed relative to the axis of an input shaft. Each of the torque generating trains has a pair of double-weight torque generators thereon wherein the weights are eccentrically mounted upon the shaft of their respective torque generating trains. However, in each torque generator a pair of substantially identical weights are mounted for freedom of rotation relative to a pair of cylindrical bearing surfaces which are eccentrically positioned relative to the axis of their torque generating train shafts and which have their eccentricities 180° apart on the shafts. As the cage of the device is spun about the axis of its torque generating train, the eccentrically mounted weights are also spun with the cage and the weights apply torque to the shafts of their torque generating trains.

### SUMMARY OF THE INVENTION

In accordance with the present invention and the contemplated problems which have and continue to exist in this field, the present invention will produce a unitary unidirectional force which may be directed angularly transversely from the central axis of rotation of the device as needed.

The invention accomplishes the above and other objects of the invention by utilizing rotating masses to achieve a unidirectional force. The operation of the device of the present invention is based on the lengthening and reduction of the radii of moving eccentric masses in relation to a common point, this point being the major axis assembly carrier shaft.

When the device of the present invention is viewed in end elevation as in FIGS. 1-4, the centerline of the carrier shaft provides a mean line of transition with the upper quadrants above the carrier shaft being in positive position and the lower quadrants being in the negative position. This relates to the resultant force of the eccentrics being in the upper mode to thereby apply a resultant force to the unit assembly. In FIGS. 1-4, the radii of the moving eccentric mass, with respect to the carrier shaft, can be measured from the mean radius of the eccentrics both in the positive and negative positions. The view of FIG. 1 discloses one internal force generating unit at the top dead center position after it has completed a 180° revolution, while FIG. 2 discloses the force generating unit rotating clockwise with the planet gears walking around the sun gear while the radius of the positive upward most eccentric is being reduced and the radius of the lower most negative eccentric is being lengthened.

In FIG. 3, the crank throw wrist pins are positioned downward. The right most eccentric is being pulled inward as the left eccentric is being pulled outwardly, and such movement of the eccentrics will cancel the resultant forces of each. Even though the wrist pins are below the mean line of transmission, the force generated by the eccentric on the right is reversed as it is being rotated counterclockwise, while the left most eccentric is being pulled clockwise which is the same direction as the assembly is rotating. The positive gear action against a negative will move the radii points upward to the transitional line, which is the centerline of the crank throws thereby employing the force pitted against the planet gears themselves. In relation to a 90° rotation as shown in FIG. 3 with the eccentrics horizontal and opposite from each other, the radius of the right most eccentric, when viewed in the drawings, is being forced to shorten thereby still exerting an outward force and the radius of the left most eccentric is being lengthened and will produce less force. To compensate for this difference in force, if needed, the timing mechanism of the invention may be installed to direct the resultant forces needed.

The radii of the eccentrics, with respect to the carrier shaft, are lengthened and shortened with the use of crank throws to which the eccentrics are mounted. The planetary gears are attached to one side of the crank throws. As the planetary gears rotate around the sun gear, which is fixedly mounted to the carrier shaft, the crank throws are rotated along with the planetary gears. When the crank throws rotate, the wrist pins are moved with respect to the centerline of the carrier shaft. The eccentrics are attached with the wrist pins. While the eccentrics are freely moveable on the wrist pins, they do not rotate. The wrist pins, however, do rotate with respect to the eccentrics. This leaves the eccentrics to seek their own path away from the wrist pins. Therefore, positive and negative eccentrics are in line with each other in regard to position of the wrist pins. If the eccentrics were held rigid, this would offset the alignment of the positive and negative eccentrics.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 is a partial elevation section view of the internal force generating units 100A and 100B of FIG. 5, showing the units in the top dead center position;

FIG. 2 is a partial elevation section view of the internal force generating units 200A and 200B of FIG. 5, showing the units rotated 45°;

FIG. 3 is a partial elevation section view of the internal force generating units 300A and 300B of FIG. 5, showing the units rotated 90°;

FIG. 4 is a partial elevation section view of the internal force generating units 400A and 400B of FIG. 5, showing the units rotated 135°;

FIG. 5 is a side elevation view, partially in section, showing an assemblage of eight internal force generating units completing one complete force generator;

FIG. 6 is an exploded perspective view of one individual internal force generating unit;

FIG. 7 is an exploded perspective view of the end mounting plates of the invention, along with the timing mechanism; and

FIG. 8 shows a graphical representation of one internal force generating unit of the invention through 180° of rotation.

### DETAILED DESCRIPTION OF THE INVENTION

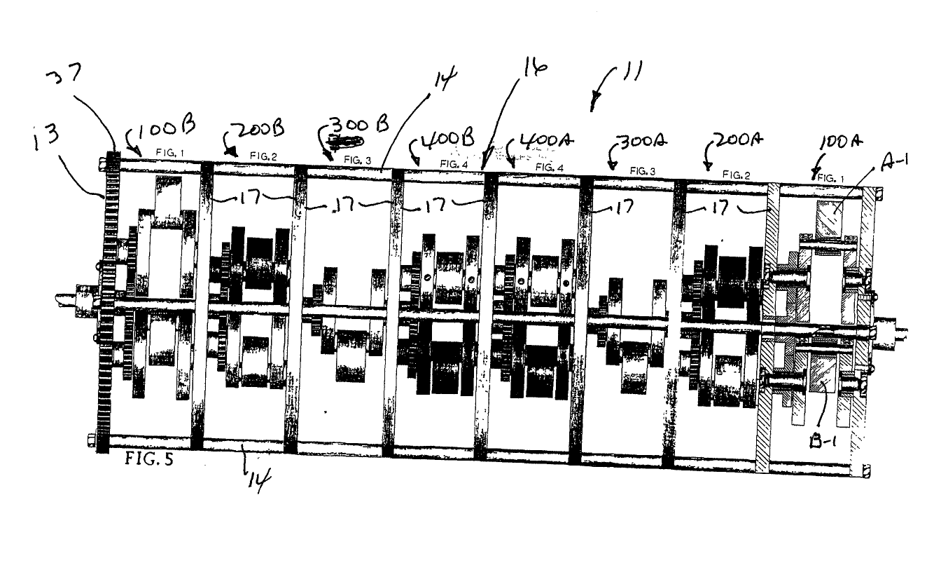

For a fuller understanding of the nature and desired objects of this invention, reference should be made to the following detailed description taken in connection with the accompanying drawings. Referring to the drawings wherein like reference numerals designate corresponding parts throughout the several figures, reference is made first to FIG. 5 showing a completed eight unit force generator 11. The force generator generally comprises a carrier cage 16 having a proximal mounting plate 12 on one end thereof and a distal mounting plate 13 on the other end thereof, interconnected by plurality of cage shafts 14. In the force generator of FIG. 5, the device is shown with eight internal force generating units identified as 100A, 100B and 200A, 200B and 300A, 300B and 400A, 400B. It should be noted that the force generator of the present invention may comprise more or less internal force generating units than is shown in FIG. 5, depending upon the use for which the force generator is to be put. Each of the internal force generating units are mounted about the carrier shaft 15, which carrier shaft is maintained fixed in a non-rotating condition and the carrier cage 16 rotates therearound carrying all of the internal force generating units therewith.

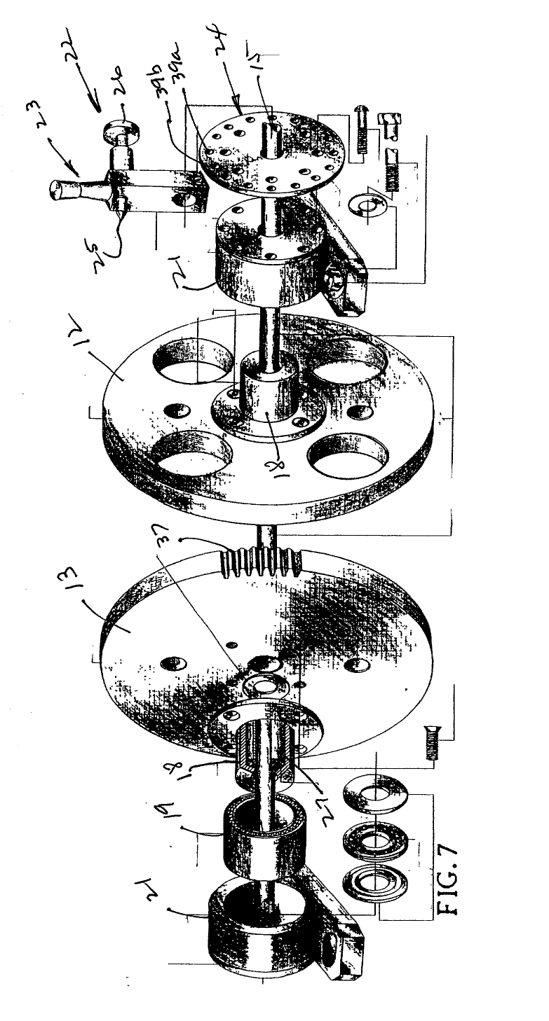

Each of the internal force generating units are divided by internal end plates 17 to which various parts of the internal force generating units are attached, except that the end-most units have the outside mounting plates 12 and 13 for mounting surfaces. Referring now to FIG. 7, the mounting plates 12 and 13 are rotatable around the carrier shaft 15 upon carrier bearing hub assemblies 18, which ride in main bearing assemblies 19 which are in turn positioned within the main bearing carrier assemblies 21.

Inasmuch as the result in output force of the present invention is unidirectional, it becomes necessary to be able to direct that force in a desired direction and, to accomplish such, a timer mechanism 22 for controlling the output direction of the resultant force produced by the force generator is shown in FIG. 7. The timing mechanism 22 of the present invention is capable of determining the resultant net unidirectional force component of the force generator, and the direction to which the force will be directed. The timing mechanism 22 is fixed to carrier shaft 15 and if the timing sequence handle 23 is rotated either clockwise or counterclockwise, as seen in FIG. 7, such movement will reposition carrier shaft 15 with respect to the carrier cage 16. As indicated in FIG. 7, the timing sequence handle 23 is affixed to the end of carrier shaft 15 and mounted adjacent to the timing plate 24, which plate has a plurality of apertures 39 angularly positioned there around to receive the detent point 25 of the locking pin 26. The timing plate 24 remains fixed to the main bearing carrier assembly 26 and will not rotate. Therefore, any movement of the timing sequence handle 23 will rotate the carrier shaft 15 and change the orientation of the internal force generating units with respect to a fixed direction.

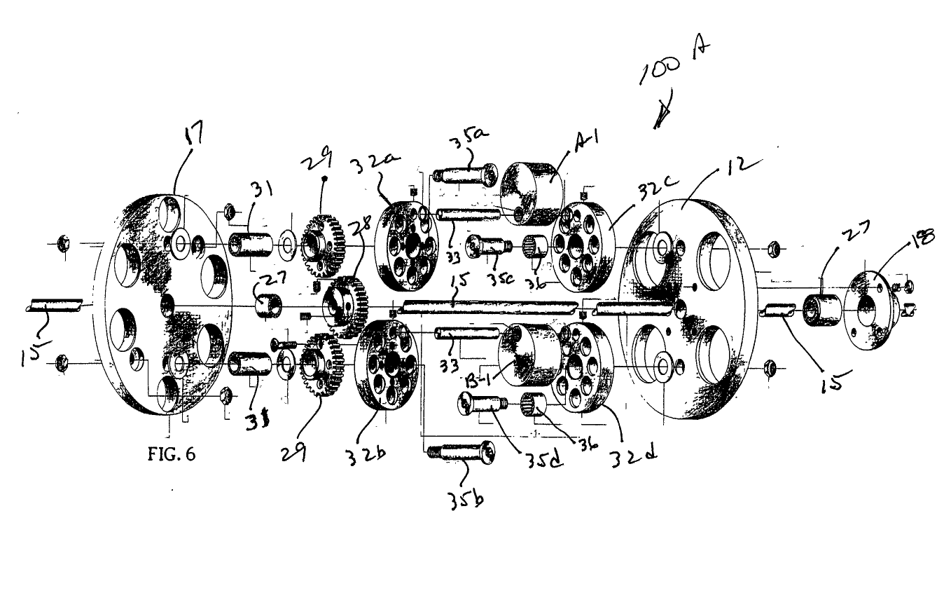

Turning now to FIG. 6 which shows an exploded view of one internal force generating unit, it will be seen that each force generating unit revolves around carrier shaft 15 as the internal end plates 17 are rotatably mounted thereupon by bearings 27. In FIG. 6, the internal force generating unit being described is unit 100A. It is noted that the other units are identical to 100A and this description is applicable to all. Unit 100A has only one internal end plate 17 while the other end plate is the proximal mounting plate 12 which has a carrier bearing 27 fixed in the carrier bearing hub assembly 18, which in turn is positioned on the mounting plate 12 to thereby allow mounting plate 12 to rotate around the carrier shaft 15. The mechanism between plates 12 and 17 will, therefore, comprise one complete internal force generating unit. The force generating unit comprises a sun gear 28 mounted to the carrier shaft 15 around which two planet gears 29 engage the sun gear and revolve there around. The planet gears 29 are mounted upon needle bearings 31 which are, in turn, mounted within the end plate 17. Each planet gear 29 is mounted to crank throw units 32a and 32b which also rotate around needle bearings 31. Positioned within one aperture of each crank throw unit is a wrist pin 33 which is affixed within the crank throw unit so that it does not rotate. Positioned upon each wrist pin is an eccentric and in the case of force generating unit 100, they are identified eccentrics A-1 and B-1. As is easily noted in the drawings, each eccentric has an aperture therein which is mounted off center, and within the aperture is an internal needle bearing 34 into which the respective wrist pin will fit to allow free rotation of the eccentric.

As should be noted, the respective wrist pins 33 project from crank throw units 32 through eccentrics A-1 and B-1, and into crank throw units 32c and 32d. As is evident, crank throws 32c and 32d are mounted to proximal mounting plate 12 by means of shoulder bolts 35c and 35d which project through suitable crank throw and needle bearings 36 through crank throws 32c and 32d, and are ultimately positioned with proximal mounting plate 12.

In operation of the present invention, a rotational force would be applied to the gear teeth 37 of the distal mounting platel 3, which would spin the entire carrier cage 16 around carrier shaft 15 carrying with it all of the internal force generating units contained therein. A discussion of the operation of the individual force generating units will apply equally to all, except in the embodiment presented herein the various sets of four units have each one offset with relation to the other in the angular direction of 45°. The embodiment shown in FIG. 5 shows two sets of four units wherein pairs of units are in the same angular disposition. The embodiment of the present invention should not be deemed limiting as the invention will produce output utilizing only one internal force generating unit, but, obviously, the force generator 11 will produce more effective unidirectional output force if there are at least four internal force generating units used in unison.

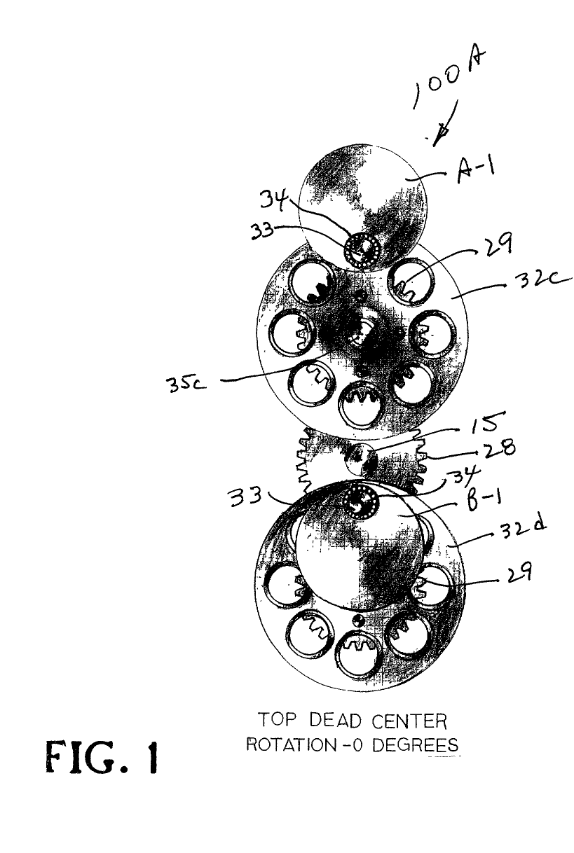

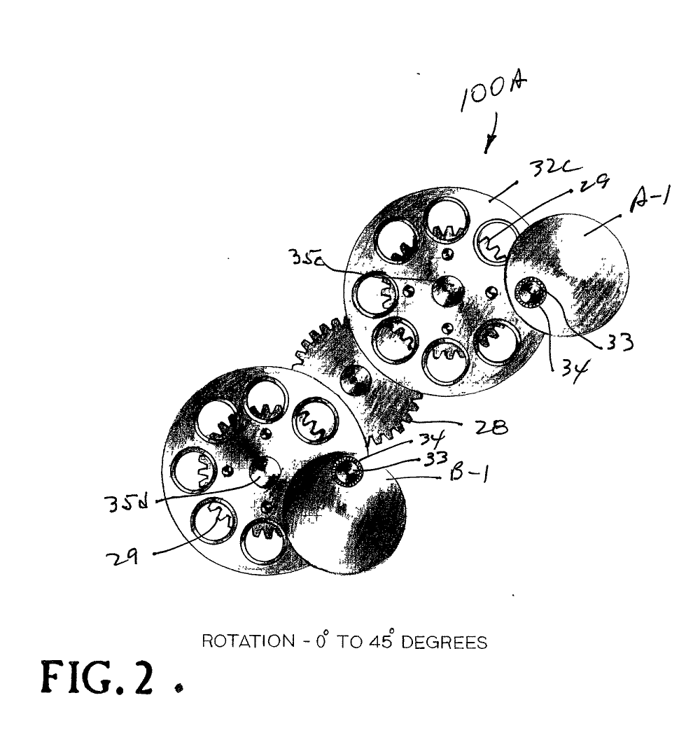

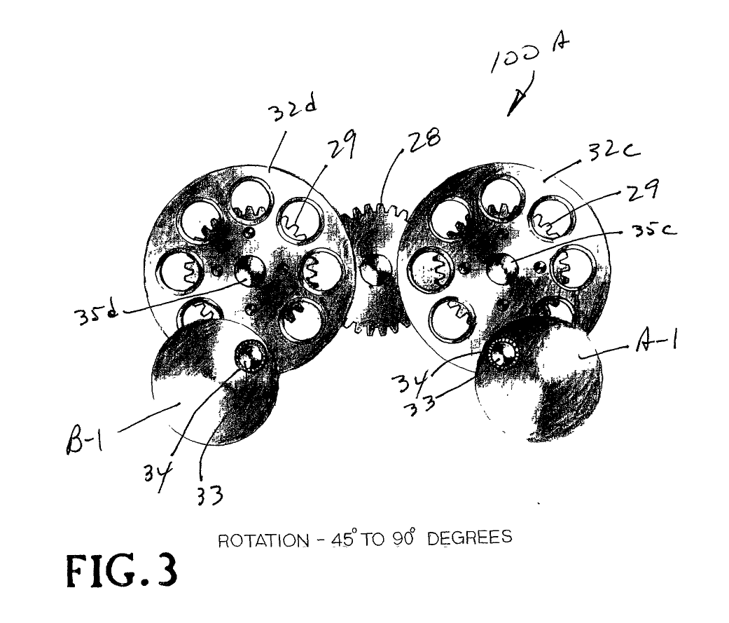

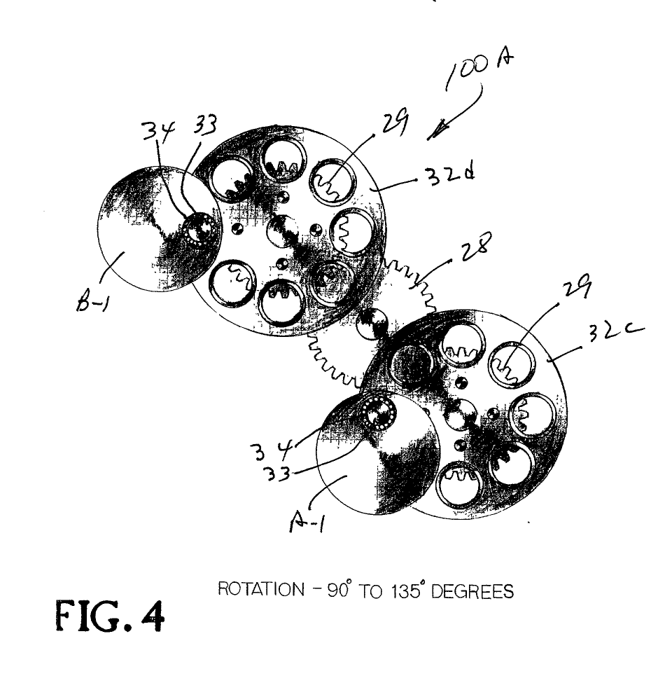

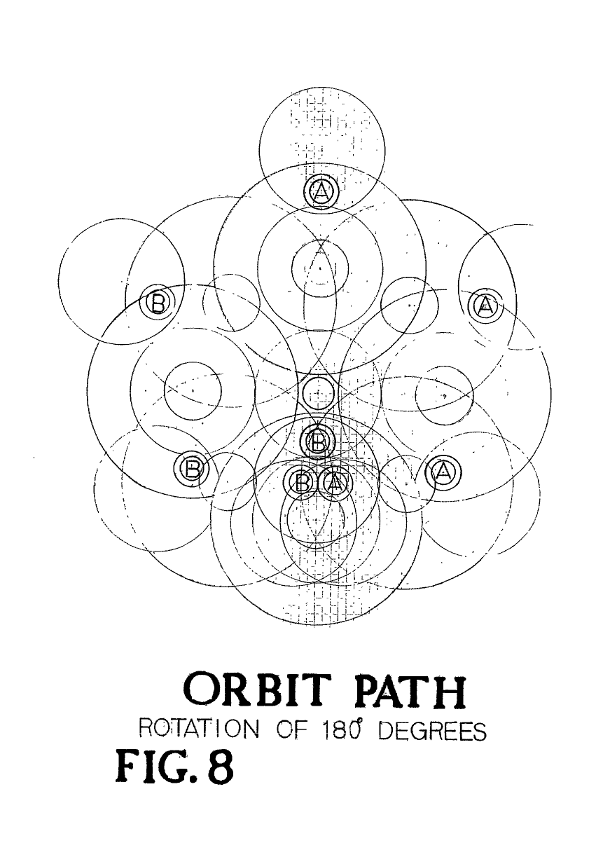

To understand the operation of the invention, it is necessary to refer to FIGS. 1-4 and FIG. 8 during this discussion. FIG. 1 shows a unit either completing a revolution or beginning a revolution, inasmuch as the unit is at top dead center at a rotation of 0°. In FIG. 2, as the carrier cage 16 is spun, the unit rotates clockwise as looking at the drawing which shows eccentric A-1 having the radius of its center of mass slightly shortening with respect to the centerline of carrier shaft 15. The radius of the center of mass of eccentric B-1 is lengthening a slight amount at the rotation of 45°. At the position shown in FIG. 3, this being a rotation of 90°, the radii of the center of masses of eccentrics A-1 and B-1 are equal to one another and the forces represented by the movement of the eccentrics cancel one another, inasmuch as the force of eccentric A-1 is moving in a counterclockwise direction whereas the resulting force of eccentric B-1 is moving in a clockwise direction and the radii are equal. FIG. 4 indicates a rotation to 135° showing the radius of the center of mass of eccentric A-1 from the centerline of carrier shaft 15 shortening while the radius of the center of mass of eccentric B-1 from the centerline of carrier shaft 15 is lengthening thereby developing a power stroke. The end of the power stroke would then be as depicted in FIG. 1, which would represent a full 180° rotation of the unit showing that eccentric B-1 is now at the top dead center and eccentric A-1 is at the bottom dead center. The radius of the center of mass of eccentric A-1 with respect to carrier shaft 15 is short, while the radius of the center of mass of eccentric B-1 with respect to shaft 15 is long, thereby indicating a full power stroke. The orbit path for a 180° revolution is fully shown in FIG. 8 and discloses the full power strokes lying well above the mean line of transition 38 indicating the net unidirectional output force of the present invention.

With respect to the timing mechanism 22, the previous discussion has been made with the assumption that the timing control handle 23 is pointed vertically and has not been rotated to effect any particular timing other than to time the unit in a vertical direction. However, if the handle 23 is rotated, and since it is fixed to the carrier shaft 15 on which the sun gear 28 is fixed, then the rotation of the handle 23 would also rotate sun gear 28. For instance, if handle 23 initially starts off in the most vertical locking aperture 39a, then the unidirectional force will be vertical as just described. However, should the handle 23 be rotated so that the detent point 25 be placed in locking aperture 39b, it will be seen that the sun gear will also rotate the same angular amount thereby positioning the individual force generating units a like amount of angular direction. In this manner, the timing mechanism changes the direction of the resultant net output force of the force generator to a position which corresponds with the timing mechanism 22 and, in this case, essentially in the direction which the position of the timing sequence handle points. Therefore, it can be seen that the timing mechanism may be used to change direction of the result and that applicable force as desired, and will allow the force generator to directly force, in any direction, transverse to the longitudinal axis of the carrier shaft 15.

Therefore, the foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A force generator comprising:
a circular rotational force input member and an end plate connected together by a plurality of cage shafts forming a carrier cage having a longitudinal centerline,
a fixed longitudinal carrier shaft positioned along the longitudinal centerline of the carrier cage, the carrier cage being rotatably mounted to the carrier shaft,
at least one internal force generating unit mounted to the carrier cage for rotation around the carrier shaft,
the carrier cage being capable of rotational movement in response to a rotational force applied to the input member,
the internal force generating unit being mounted between a proximal mounting plate and a distal mounting plate, the mounting plates being affixed to the cage shafts and rotatable on the carrier shaft,
each internal force generating unit having a sun gear locked to the carrier shaft adjacent one of the mounting plates, first and second planet gears engaging the sun gear and respectively mounted in rotational relationship to one of the mounting plates, first and second crank throw units, a first crank throw unit mounted to the first planet gear and a second crank throw unit mounted to the second planet gear,
a third crank throw unit rotationally mounted to the other of said mounting plates and a fourth crank throw unit rotationally mounted to the other of said mounting plates,
an eccentric being mounted between the first and third crank throws and being freely rotatable about a wrist pin interconnecting the first and second crank throws, and
a second eccentric being mounted between the second and fourth crank throws and being freely rotatable about a wrist pin interconnecting the second and fourth crank throws.

2. A force generator as claimed in claim 1, wherein multiple internal force generating units are mounted to the carrier cage.

3. A force generator as claimed in claim 2, wherein the centerline of the carrier shaft and a centerline passing through each wrist pin of an individual force generating unit lie in a common plane.

4. A force generator as claimed in claim 3, wherein the common planes of respective individual force generating units are offset 45 angular degrees from adjacent individual force generating units.

5. A force generator as claimed in claim 4 further comprising a timing mechanism connected to the carrier shaft to change the phase relationship between the carrier shaft and the carrier cage to angularly vary the resultant force output.

6. A force generator as claimed in claim 2, wherein the internal force generating units are juxtaposed end to end.

7. A force generator as claimed in claim 3, wherein the internal force generating units are juxtaposed end to end.

8. A force generator as claimed in claim 7, wherein there are four internal force generating units grouped in one set with the common plane of each generating unit of the set being angularly disposed 45° with respect to the common plane of any adjacent generating unit.
